(19) United States
(12) Patent Application Publication
(10) Pub. No.: US 2026/0240716 A1
(43) Pub. Date: Aug. 20, 2026

(54) PLEASURE MEASURING DEVICE, METHOD, AND SYSTEMS

(71) Applicant: Shant Razoo Abdo, Granada Hills, CA (US)

(72) Inventor: Shant Razoo Abdo, Granada Hills, CA (US)

(21) Appl. No.: 19/310,635

(22) Filed: Aug. 26, 2025

Related U.S. Application Data
(60) Provisional application No. 63/760,483, filed on Feb. 19, 2025.

(51) Int. Cl. A61H 19/00; A61H 9/00; A61H 23/02

(52) U.S. Cl. CPC A61H 19/44; A61H 9/0057; A61H 23/02; A61H 2201/0188; A61H 2201/5064

(57) ABSTRACT

A device, method, and or system involving the integration of an adult toy and several measurement systems, including a length measurement system and a girth system for measuring girth, wherein the measurement systems can measure and detect the performance of the user in terms of depth penetration and the amount of girth received. The disclosure further includes the incorporation of various sensors, materials, and power sources.

### CROSS REFERENCE

The application claims priority from the U.S. Patent Application with Ser. No. 63/760,483, entitled “Adult Novelty Toy with Integrated Depth Measurement System” filed on Feb. 19, 2025, and which is incorporated herein by reference in its entirety.

### TECHNICAL FIELD

The present disclosure related to the field of adult novelty toys. Specifically, the present invention relates to a novel and inventive device, method and system for the field of adult toys.

### BACKGROUND

The present disclosure related to the field of adult novelty toys in the form of devices, methods, and systems, wherein the toy has an integrated depth measurement system and related capabilities.

Currently there is no product on the market that allows measurement of the depth an adult novelty toy is inserted during usage. This device, method, system, allows this type of measurement along with additional novel and inventive capabilities.

### SUMMARY

Aspects and advantages of the invention will be set forth in the following description, or may be obvious from the description, or may be learned through practice of the invention.

In some embodiments, the device includes a top side, a front side, a back side, a bottom side, a left side, a right side, a length, a girth, and a measurement system wherein the measurement system measures the length of the device.

In some embodiments, the device includes a top side, a front side, a back side, a bottom side, a left side, a right side, a length, a girth, and a measurement system wherein the measurement system measures the length of the device, wherein the device further comprises of measurement system measures for length that facilitates measuring how deep the device is inserted.

In some embodiments, the device includes a top side, a front side, a back side, a bottom side, a left side, a right side, a length, a girth, and a measurement system wherein the measurement system measures the length of the device, wherein the device further comprises a girth system for the purpose of measuring girth.

In some embodiments, the device includes a top side, a front side, a back side, a bottom side, a left side, a right side, a length, a girth, and a measurement system wherein the measurement system measures the length of the device, wherein the device further comprises a girth system for the purpose of measuring girth, wherein the girth system is the second measurement system.

In some embodiments, the device includes a top side, a front side, a back side, a bottom side, a left side, a right side, a length, a girth, and a measurement system wherein the measurement system measures the length of the device, wherein the device is color coded based on the size of the girth of the device.

In some embodiments, the device includes a top side, a front side, a back side, a bottom side, a left side, a right side, a length, a girth, and a measurement system wherein the measurement system measures the length of the device, wherein the measurement system comprises of a series of numbers to indicate the length of the device that is inserted.

In some embodiments, the device includes a top side, a front side, a back side, a bottom side, a left side, a right side, a length, a girth, and a measurement system wherein the measurement system measures the length of the device, wherein the measurement system comprises of a series of numbers to indicate the length of the device that is inserted, wherein the device further comprises a portable energy source wherein the measurement system is illuminated.

In some embodiments, the device includes a top side, a front side, a back side, a bottom side, a left side, a right side, a length, a girth, and a measurement system wherein the measurement system measures the length of the device, wherein the measurement system comprises of a series of numbers to indicate the length of the device that is inserted, wherein the device further comprises a portable energy source wherein the measurement system is illuminated wherein the measurement system is illuminated based on the depth of the device is inserted during use.

In some embodiments, the device includes a top side, a front side, a back side, a bottom side, a left side, a right side, a length, a girth, and a measurement system wherein the measurement system measures the length of the device, wherein the device further comprises of a suction component wherein the suction component is on the bottom of the device.

In some embodiments, the device includes a top side, a front side, a back side, a bottom side, a left side, a right side, a length, a girth, and a measurement system wherein the measurement system measures the length of the device, wherein the device vibrates.

In some embodiments, the device includes a top side, a front side, a back side, a bottom side, a left side, a right side, a length, a girth, and a measurement system wherein the measurement system measures the length of the device, wherein the vibration sequence of the device is dependent upon the depth the device is inserted during use.

In some embodiments, the device includes a top side, a front side, a back side, a bottom side, a left side, a right side, a length, a girth, and a measurement system wherein the measurement system measures the length of the device, wherein the measurement system uses symbols.

In some embodiments, the device includes a top side, a front side, a back side, a bottom side, a left side, a right side, a length, a girth, and a measurement system wherein the measurement system measures the length of the device, wherein the sexual penetration device is in the shape of dildo.

In some embodiments, the device includes a top side, a front side, a back side, a bottom side, a left side, a right side, a length, a girth, and a measurement system wherein the measurement system measures the length of the device. wherein the device is curved.

In some embodiments, the device includes a top side, a front side, a back side, a bottom side, a left side, a right side, a length, a girth, and a measurement system wherein the measurement system measures the length of the device, wherein the girth of the device varies in a wave manner along the length of the device.

In some embodiments, the device includes a top side, a front side, a back side, a bottom side, a left side, a right side, a length, a girth, and a measurement system wherein the measurement system measures the length of the device, wherein the device further comprises of a suction component.

In some embodiments, the invention is a system comprising of a sexual penetration device comprises of a measurement system that measures the length of the device and further comprises of a length and a girth is provided.

In some embodiments, a method for measuring insertion depth of an adult insertion device, the method comprising, providing an adult insertion device with a measurement system, inserting the adult insertion device, and viewing the insertion depth by comparing to the number on the measurement system.

### BRIEF DESCRIPTION OF THE FIGURES

A full and enabling disclosure of the present invention, including the best mode thereof, directed to one of ordinary skill in the art, is set forth in the specification, which makes reference to the appended drawings in, which:

FIG. 1 is a top, front, left perspective view of the device, wherein the measurement system is in inches.

FIG. 2 is a bottom, top, left perspective view of the device, wherein the measurement system is in inches, and the suction component is clearly shown.

FIG. 3 is a bottom, top, left perspective view of the device, wherein the measurement system is in inches.

FIG. 4 is a front and top perspective view of the device.

FIG. 5 is a view of the bottom side of the device.

FIG. 6 is a view of the left side of the device.

FIG. 7 is a view of the right side of the device.

FIG. 8 is a view of the front side of the device.

FIG. 9 is a view of the back side of the device.

FIG. 10 is a top, front, left perspective view of the device, wherein the measurement system is in inches and protrusions in the shape of veins are shown.

FIG. 11 is a bottom, back, left perspective view of the device, wherein the view is zoomed in and wherein the girth system is shown.

Repeat use of the reference characters in the present specification and drawings is intended to represent the same or analogous features or elements of the present invention.

### DETAILED DESCRIPTION

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

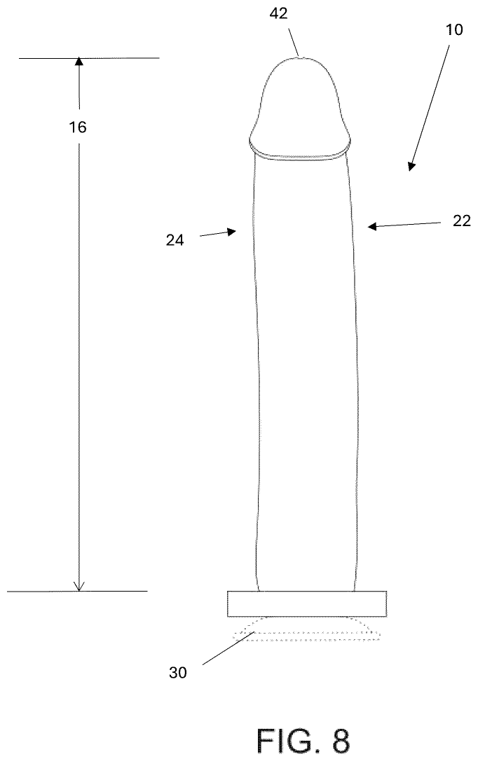

In accordance with the present invention, a disclosure is made of a device, method and system that provides sexual pleasure, insertion information and performance information. The device (10) is embodied as a sexual penetration device (10) that is designed to provide sexual pleasure as it penetrates the user. Other common names for this type of device are dildo, insertable sexual aid device, phallic prosthesis, penile analog, and phallic insertable toy. The top (12) of the device (10) is the portion of the device (10) that first penetrates or enters the user. The bottom (14) of the device (10) is the side that is opposite of the top (12) of the device (10). The length (16) of the device (10) is defined as the distance from the top (12) of the device (10) to the bottom (14). FIG. 8 shows how length (16) is generally defined. The other sides of the device (10) are identified as the front (18) back (20) left (22) and right (24). The circumference of the device (10) is defined as the perimeter around the front (18) back (20) left (22) and right (24) sides of the body (26) of the device (10). The term girth is used throughout the application and is interchangeable with circumference. Another understanding for the same measurement would be the girth or circumference is the length to wrap around the front (18) back (20) left (22) and right (24) of the body (26). The body (26) of the device is generally an elongated shaft having a proximal and distal end.

The terms “depth” “insertion depth” or “depth inserted by user” or “depth of insertion” or any derivative of this, is defined to refer to the depth the device (10) is inserted into the user. The term “user” is defined to refer to the person the device (10) is inserted into. This definition does not necessarily require that the user has control of the device (10) to be considered the user.

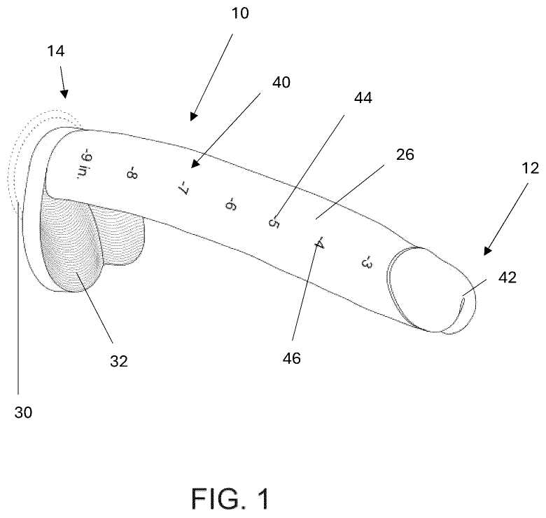

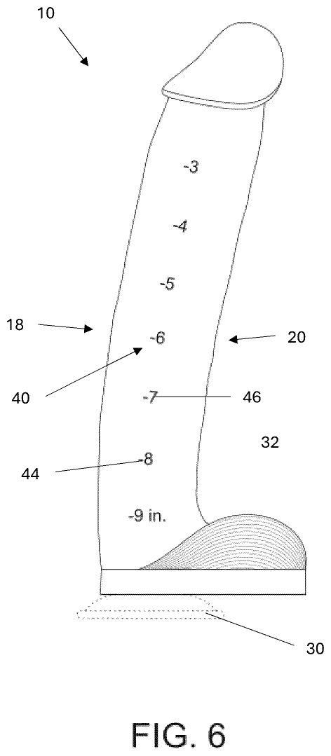

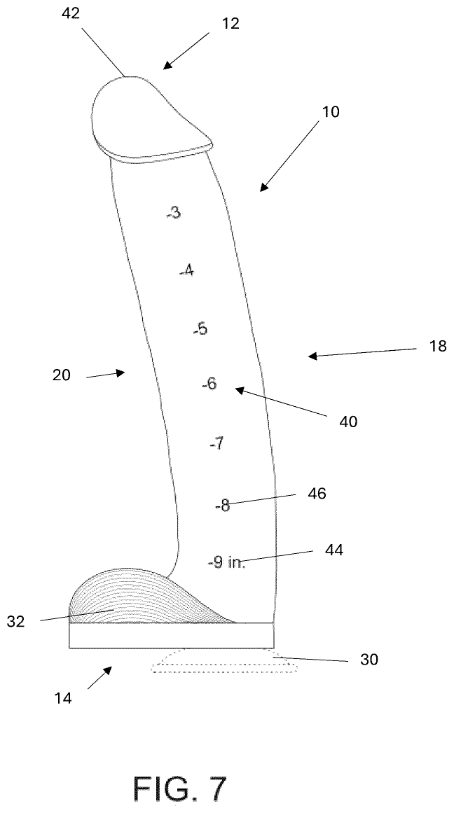

The device (10) provides a measurement system (40) that allows the user to measure the depth the device (10) is inserted into the user. The measurement system (40) can be a numerical system (44) that is based on the imperial system or US Customary system, wherein the numbers represent inches. The measurement system (40) can be a numerical scale (44) that is based on the metric system, wherein the numbers represent centimeters or millimeters. The measurement system (40) can be a numerical scale (44) that uses integers or a continuous number such as numbers in decimal form. The measurement system (40) can be a numerical scale (44) that also includes dashes for purposes of enabling the identification of the precise distance inserted. The measurement system (40) can be a series of colors, wherein the color of the device (10) changes at certain sections of length (16) of the device (10). For example, the first inch could be colored as red, the second inch could be colored as blue the third inch could be colored as red again. The colors can be repeating or completely different or randomly repeating. The measurement system (40) can use symbols instead of numbers. For example, the first inch could be identified by a smile face the second inch identified by a peace sign. Any various symbols could be used in any order. The measurement system (40) can be placed on any of the four vertical sides of the device (10), previously identified as the front (18), back (20), left (22) and right (24). The measurement system (40) can be placed on multiple sides. All embodiments of the measurement system (40) start at the top tip (42) of the device (10) and measures down towards the bottom (14) increasing in value. For example, in some embodiments that are using numbers and the US Customary system as the units of the measurement system (40), one inch from the top tip (42) is designated with a numerical “1”, two inches from the top tip (42) is designated with a numerical “2” and so on. Dashes can also be used when colors or symbols utilized by the device (10) for measurement purposes. “The numerical scale (44) can be configured such that the orientation of the numbers can align with any side of the device. For example, in FIG. 1, the numerical scale (44) the top (12) of the numbers align with the top (12) of the device (10) so that when viewed the top (12) of the number (46) of the numerical scale (44) is oriented in the same direction as the top (12) of the device (10). The numerical scale (44) does not have to start with a numerical “1.” For example, in FIG. 1, the numerical scale (44) starts with “3” and is based on the US customary system wherein the “3” represents inches. As stated previously, the measurement system (40) can be placed on multiple sides. As shown in FIGS. 6 and 7, the measurement system (40) is shown on the left (22) and right sides. It is intended to demonstrate that the measurement system (40) is in no way limited in placement as long as it reasonably estimates length (16) as shown throughout the drawings. The measurement system (40) is not designed to be accurate to a scientific level and may have slight inaccuracies in situations of curve(s).

The invention may be provided distinguishing titles based on the size and shape characteristics of the device (10). For example, a small version of the device (10) may be titled “newbie” “beginner” or “rookie” as some nonlimiting examples. Another example is a large version of the device (10) being titled “experienced” or “G.O.A.T” as some nonlimiting examples. In some embodiments, the device (10) lacks a measurement system (40) and the distinguishing title is implemented instead to distinguish to the use the size and shape characteristics of the device (10). In some embodiments, the device (10) includes both the measurement system (40) and the distinguishing titles. In some embodiments, the device (10) lacks a girth system (50) and the distinguishing title is implemented instead to distinguish to the use the size and shape characteristics of the device (10). In some embodiments, the device (10) includes both the girth system (50) and the distinguishing titles. In some embodiments, the device (10) lacks a measurement system (40) and a girth system (50) and the distinguishing title is implemented instead to distinguish to the user the size and shape characteristics of the device (10). In some embodiments, the device (10) includes a measurement system (40) and a girth system (50) and the distinguishing titles. In some embodiments the category names correspond to numbers or level of insertion.

In some embodiments, the “Rookie” category corresponds to 3 inches. In some embodiments, the “Veteran” category corresponds to 6 inches. In some embodiments, the “GOAT” category corresponds to 9 inches. In some embodiments instead both the category system and the measurements system (40) are used, wherein at the 3-inch mark, the 3-inch mark is shown on one side the and the category label “Rookie” is shown on the other at the same corresponding distance in length. In some embodiments instead both the category system and the measurements system (40) are used, wherein at the 6-inch mark, the 6-inch mark is shown on one side the and the category label “Veteran” is shown on the other at the same corresponding distance in length. In some embodiments instead both the category system and the measurements system (40) are used, wherein at the 9-inch mark, the 9-inch mark is shown on one side the and the category label “GOAT” is shown on the other at the same corresponding distance in length. Overall, various embodiments of the device can have varying terms at varying lengths. There is no limitation on the types of terms that can be used or the types of measurement scales being used (metric, US. Customary). Additionally, similar to the number (46) (46) there is no limitation on which side of the device the label can be placed or how many times it can be placed. For example, the front and back sides may have the category label, and the left and right sides may have the number (46). In some embodiments there are no numbers (46) and simply only categories. For example, an embodiment of the device may have “Rookie,” “Veteran,” and “G.O.A.T” at different lengths of the device with no numbers (46) being present. Also, the various embodiments of the categories and the number (46) system of the measurement system (40) can be incorporated into the girth system (50). Furthermore, all the various embodiments previously disclosed in this paragraph can be present in both the measurement system (40) and the girth system (50). In some embodiments, there will be a correspondence between the level of proficiency associated with the categorical term used and the corresponding depth associated with that categorical term. For example, Rookie would be used in coordination with a lower value of insertion depth than the term “Veteran” or “G.O.A.T.”

The device (10) can have varying girth. For example, the girth of the device (10) may be its smallest at the top tip (42) and largest towards the bottom (14). Additionally, the girth can vary in a wave manner wherein it increases and decreases along the length (16) of the device (10).

The device (10) can also include a second system for measuring girth, identified as a girth system (50). The girth system (50) may use any of the number, color or symbol units previously described for the measurement system (40). In some embodiments the girth system (50) and the measurement system (40) may use the same type of units such as, but not limited to, both being numerical based. In some embodiments the units of the girth system (50) may be based on one type of unit while the measurement system (40) is based on another type of unit. For example, the measurement system (40) may use a numerical scale (44), and the girth system (50) may use a color scale. If both systems use a numerical scale (44) the invention does not require that both systems use the same numerical scale (44). For example, the girth system (50) could be based on the metric units while the measurement system (40) could be based on the US Customary system (inches). In some embodiments, the girth system (50) is present, and the measurement system (40) is not.

In some embodiments the device (10) is curved in relation to its length (16). The direction of this curve is non limiting. The device (10) can be curved in the directions of up, down, left, or right. The device (10) can be double-curved in any combination of up, down, left, or right. For example, the device (10) can be curved up and left or down and right or any other combination.

In some embodiments, the bottom (14) of the device (10) can have a component that assists the user with gripping the device (10). In some embodiments, the bottom (14) of the device (10) is just a continuation of the body of the device (10). In some embodiments, the bottom (14) of the device (10) includes a suction component (30), that is designed to hold to surfaces and support the device (10) as a whole. In some embodiments, the bottom (14) of the device (10) includes a suction component, that is designed to hold to flat surfaces and support the device (10) as a whole, and the suction component (30) is detachable. In some embodiments, the bottom (14) of the device (10) includes a component that resembles testicles (32). In some embodiments, the bottom (14) of the device (10) includes a component that resembles testicles (32) and a component for gripping. In some embodiments, the bottom (14) of the device (10) includes a component that resembles testicles (32) and a suction component (30). In some embodiments, the bottom (14) of the device (10) includes a component that resembles testicles (32) and a component for gripping and a suction component (30).

In some embodiments, the device (10) will include one or more lights. The lights will be powered by a power source inside the device (10). In some embodiments, the power source is rechargeable. The lights can be placed for decorative purposes and vary in color and intensity. The lights can also be set to flash, change colors, flash to a set beat, flash randomly or any combination of these settings. The lights can also be configured to assist with the measurement system (40) by illuminating the numbers or scale units used. The lights can also be configured to assist with the girth system (50) by illuminating the numbers or scale units used. In some embodiments the lights are configured to demonstrate how deep the device (10) was inserted. For example, if the device (10) is inserted to a depth of five inches, only the five is illuminated. In another example, if the device (10) is inserted to a depth of five inches, five and every number after that (six, seven, eight, and so on) is illuminated. In another example, if the device (10) is inserted to a depth of five inches, five and every number before that (four, three, two, one) is illuminated.

In some embodiments, the bottom (14) of the device (10) has a screen, wherein the screen provides displays insertion data. In some embodiments the insertion data displayed is the deepest depth reached during a session of use. In some embodiments the insertion data displayed is the current depth of the device (10) in the user. The insertion data displayed can be in integer or decimal number form.

In some embodiments, the device (10) will include the capability of vibrating. In some embodiments, the device (10) will have varying vibration cycles. In some embodiments, the vibration cycle is determined by the depth the device (10) is inserted and can change based on the depth increasing or decreasing.

The device (10) can be of various colors. The device (10) can be the color of human skin, any solid color or any mix of colors. In some embodiments, the color material of the device (10) is configured in a manner to look and feel lifelike. In some embodiments, the lifelike elastomers are used to create the lifelike effect. In some embodiments, the device (10) is made of material that is non-lifelike. In some embodiments, the device (10) is made of material that is non-lifelike such as gelatin-based compositions. In some embodiments, the device (10) is made of material that is non-lifelike such as phthalate-plasticized polyvinyl chloride compositions. In some embodiments, the device (10) is made of material that is non-lifelike such as thermoplastic elastomer (TPE), thermoplastic rubbers (TPR), acrylonitrile butadiene styrene (ABS), or polycarbonate.

In some embodiments, the body (60) of the device (10) has one or more protrusions (34). In some embodiments, the body (60) of the device (10) has one or more protrusions (34) that are designed to resemble veins (36). In some embodiments the units of the measurement system (40) are protrusions (34). In some embodiments the units of the girth system (50) are protrusions (34).

The invention can also be a system consisting of several devices (10). The devices can be of varying lengths and girth sizes. In some embodiments, the system consists of several devices that vary in girth and color wherein the color is used to distinguish the girth of the device (10). In some embodiments, the system consists of several devices that vary in length (16) and color wherein the color is used to distinguish the length (16) of the device (10).

In some embodiments, the device (10) is made of silicone. In some embodiments, the device (10) is made of polyvinyl chloride (PVC). In some embodiments, the device (10) is made of thermoplastic elastomers (TPEs). In some embodiments, the device (10) is made of polyurethane. In some embodiments, the device (10) is made of polyethylene or polypropylene. In some embodiments, the device (10) is made of acrylonitrile butadiene styrene (ABS). In some embodiments, the device (10) is made of polycarbonate. In some embodiments, the device (10) is made of biodegradable polymers such as polylactic acid (PLA) or polyhydroxyalkanoates (PHAs). In some embodiments, the device (10) is made of natural rubber or synthetic rubber compounds. In some embodiments, the device (10) is made of latex or nitrile. In some embodiments, the device (10) is made of a single uniform material throughout its structure. In some embodiments, the device (10) is made of a combination of materials where different components or segments are composed of different materials selected from the aforementioned group. In some embodiments, the device (10) is made of a heterogenous mixture of materials randomly distributed throughout its body. In some embodiments, the device (10) is made of layered materials. In some embodiments, the device (10) is made of elastomeric blends that combine multiple rubber or plastic materials. In some embodiments, the device (10) is made of filled polymers, such as silicone filled with silica or PVC filled with calcium carbonate. In some embodiments, the device (10) is made of co-molded or co-extruded materials wherein two or more polymers are processed together. In some embodiments, the device (10) is made of recycled or post-consumer materials in whole or in part. In some embodiments, the device (10) is made of thermoset plastics. In some embodiments, the device (10) is made of elastomeric foam or closed-cell foamed plastic. In some embodiments, the device (10) is made of high-performance engineering plastics such as PEEK or PTFE. In some embodiments, the device (10) is made of medical-grade polymers compliant with FDA or ISO standards. In some embodiments, the device (10) is made of any other suitable natural, synthetic, or semi-synthetic material known to those skilled in the art, including future-developed polymeric or elastomeric compounds. In some embodiments, the device (10) is made of composite materials combining two or more materials.

As shown in FIG. 1, is an embodiment of the device wherein the device includes a measurement system (40) for length (16) wherein the measurement system (40) utilizes a numerical scale (44). In this embodiment, the bottom (14) of the device (10) includes both a suction component (30) and a component resembling testicles (32). In FIG. 1, the top (12), front (18) and left (22) sides of the device (10) are predominately shown. In FIG. 1, the numerical scale (44) the top of the numbers aligns with the top (12) of the device (10) so that when viewed the top of the number (46) of the numerical scale (44) is oriented in the same direction as the top (12) of the device (10). In FIG. 1, the numerical scale (44) starts with “3” and is based on the US customary system wherein the “3” represents inches, demonstrating the numerical scale (44) does not have to start with a numerical “1.”

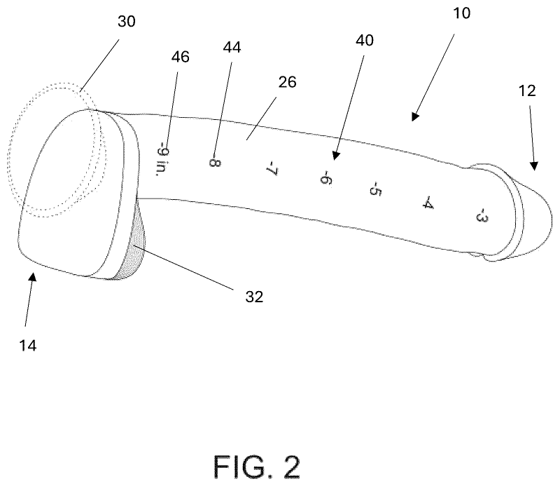

As shown in FIG. 2, is an embodiment of the device wherein the device includes a measurement system (40) for length (16) wherein the measurement system (40) utilizes a numerical scale (44). In this embodiment, the bottom (14) of the device (10) includes both a suction component (30) and a component resembling testicles (32). In FIG. 2, the back (20) and left (22) sides of the device (10) are predominately shown. In FIG. 2, the numerical scale (44) the top of the numbers aligns with the top (12) of the device (10) so that when viewed the top of the number (46) of the numerical scale (44) is oriented in the same direction as the top (12) of the device (10). In FIG. 2, the numerical scale (44) starts with “3” and is based on the US customary system wherein the “3” represents inches, demonstrating the numerical scale (44) does not have to start with a numerical “1.”

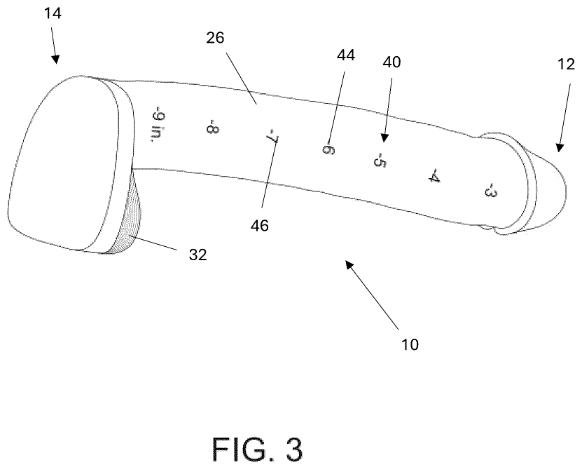

As shown in FIG. 3, is an embodiment of the device wherein the device includes a measurement system (40) for length (16) wherein the measurement system (40) utilizes a numerical scale (44). In this embodiment, the bottom (14) of the device (10) includes a component resembling testicles (32). In FIG. 3, the back (20) and left (22) sides of the device (10) are predominately shown. In FIG. 3, the numerical scale (44) the top of the numbers aligns with the top (12) of the device (10) so that when viewed the top of the number (46) of the numerical scale (44) is oriented in the same direction as the top (12) of the device (10). In FIG. 3, the numerical scale (44) starts with “3” and is based on the US customary system wherein the “3” represents inches, demonstrating the numerical scale (44) does not have to start with a numerical “1.”

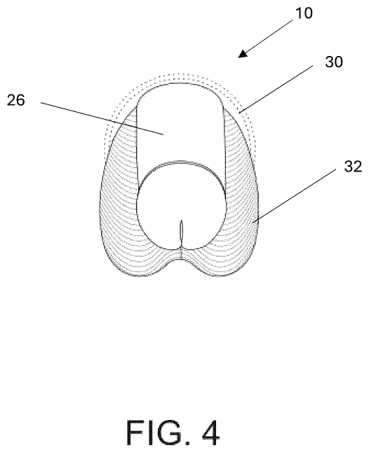

As shown in FIG. 4, is an embodiment of the device wherein the device includes a measurement system (40) for length (16) wherein the measurement system (40) utilizes a numerical scale (44). In this embodiment, the bottom (14) of the device (10) includes both a suction component (30) and a component resembling testicles (32). In FIG. 4, the front (18) and top (12) sides of the device (10) are predominately shown.

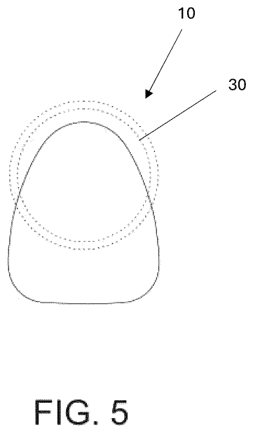

As shown in FIG. 5, is an embodiment of the device wherein the device includes a measurement system (40) for length (16) wherein the measurement system (40) utilizes a numerical scale (44). In this embodiment, the bottom (14) of the device (10) includes both a suction component (30) and a component resembling testicles (32). In FIG. 5, the back (20) side of the device (10) is predominately shown.

As shown in FIG. 6, is an embodiment of the device wherein the device includes a measurement system (40) for length (16) wherein the measurement system (40) utilizes a numerical scale (44). In this embodiment, the bottom (14) of the device (10) includes a component resembling testicles (32). In FIG. 6, the left (22) side of the device (10) is predominately shown. In FIG. 6, the numerical scale (44) the top of the numbers aligns with the top (12) of the device (10) so that when viewed the top of the number (46) of the numerical scale (44) is oriented in the same direction as the top (12) of the device (10). In FIG. 6, the numerical scale (44) starts with “3” and is based on the US customary system wherein the “3” represents inches, demonstrating the numerical scale (44) does not have to start with a numerical “1.” In FIG. 6, the device (10) shows a slight downward curvature.

As shown in FIG. 7, is an embodiment of the device wherein the device includes a measurement system (40) for length (16) wherein the measurement system (40) utilizes a numerical scale (44). In this embodiment, the bottom (14) of the device (10) includes a component resembling testicles (32). In FIG. 7, the right side of the device (10) is predominately shown. In FIG. 7, the numerical scale (44) the top of the numbers aligns with the top (12) of the device (10) so that when viewed the top of the number (46) of the numerical scale (44) is oriented in the same direction as the top (12) of the device (10). In FIG. 7, the numerical scale (44) starts with “3” and is based on the US customary system wherein the “3” represents inches, demonstrating the numerical scale (44) does not have to start with a numerical “1.” In FIG. 7, the device (10) shows a slight downward curvature.

As shown in FIG. 8, is an embodiment of the device wherein the device includes a measurement system (40) for length (16) wherein the measurement system (40) utilizes a numerical scale (44). In this embodiment, the bottom (14) of the device (10) includes both a suction component (30) and a component resembling testicles (32). In FIG. 8, the top (12) side of the device (10) is predominately shown.

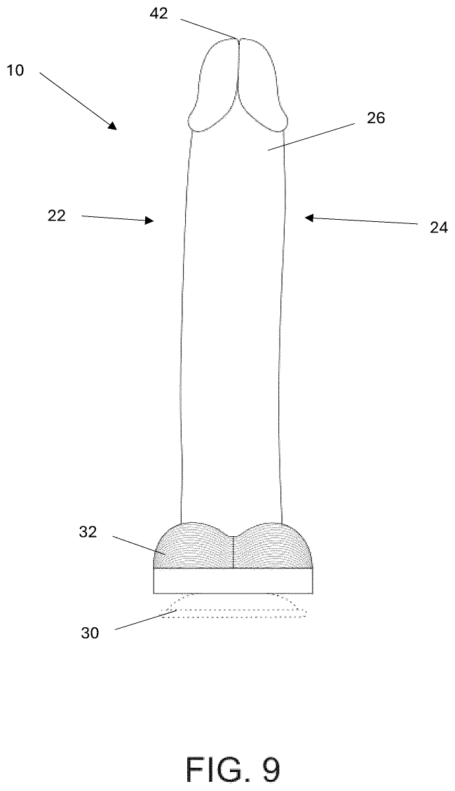

As shown in FIG. 9, is an embodiment of the device wherein the device includes a measurement system (40) for length (16) wherein the measurement system (40) utilizes a numerical scale (44). In this embodiment, the bottom (14) of the device (10) includes both a suction component (30) and a component resembling testicles (32). In FIG. 5, the top (12) side of the device (10) is predominately shown.

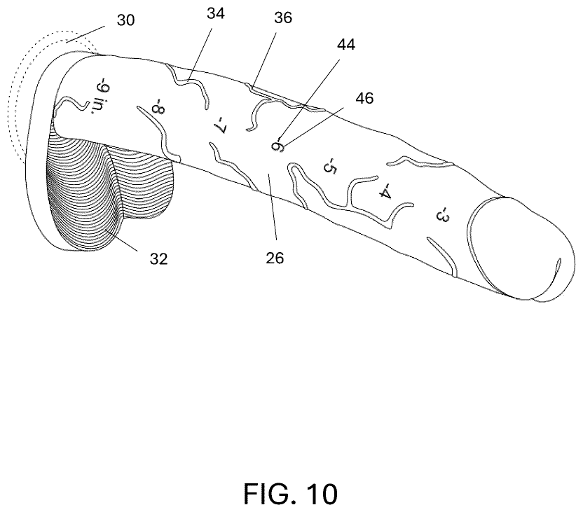

As shown in FIG. 10, is an embodiment of the device wherein the device includes a measurement system (40) for length (16) wherein the measurement system (40) utilizes a numerical scale (44). In this embodiment, the bottom (14) of the device (10) includes both a suction component (30) and a component resembling testicles (32). In FIG. 10, the top (12), front (18) and left (22) sides of the device (10) are predominately shown. In FIG. 10, the numerical scale (44) the top of the numbers aligns with the top (12) of the device (10) so that when viewed the top of the number (46) of the numerical scale (44) is oriented in the same direction as the top (12) of the device (10). In FIG. 10, the numerical scale (44) starts with “3” and is based on the US customary system wherein the “3” represents inches, demonstrating the numerical scale (44) does not have to start with a numerical “1.” In FIG. 10, the body of the device (10) has protrusions (34), wherein the protrusions (34) are configured to resemble veins (36) in both placement and shape.

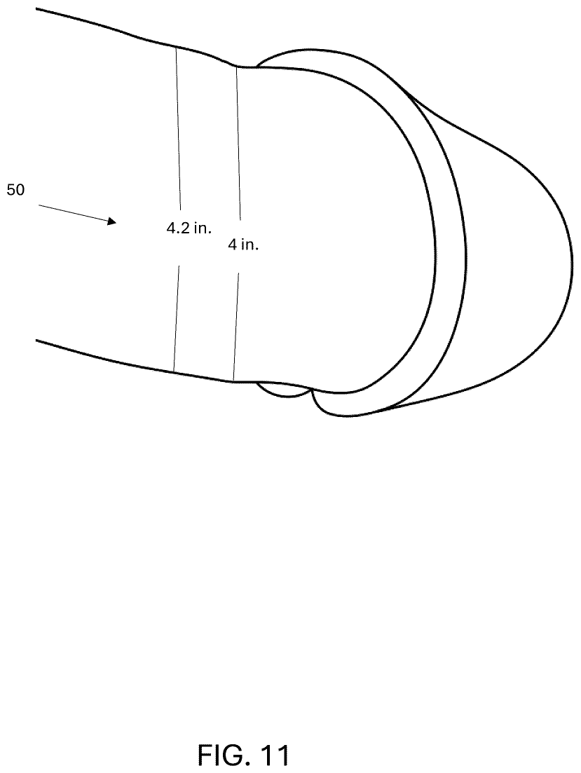

FIG. 11 is an embodiment showing the difference in girth at two points on the device (10) wherein the girth system (50) demonstrates this difference.

The images are intended to be explanatory, not limiting. Any combination or embodiment not shown in the images is in no way excluded from embodiments taught by this disclosure.

What is claimed is:

1. A sexual penetration device comprises of a top side, a front side, a back side, a bottom side, a left side, a right side, a length, a girth, and a measurement system wherein the measurement system measures the length of the device.

2. The device of claim 1 wherein the device further comprises of measurement system measures for length that facilitates measuring how deep the device is inserted.

3. The device of claim 1 wherein the device further comprises a girth system for the purpose of measuring girth.

4. The device of claim 1, wherein the device further comprises a girth system for the purpose of measuring girth, wherein the girth system is the second measurement system.

5. The device of claim 1, wherein the device is color coded based on the size of the girth of the device.

6. The device of claim 1, wherein the measurement system comprises of a series of numbers to indicate the length of the device that is inserted.

7. The device of claim 6, wherein the device further comprises a portable energy source wherein the measurement system is illuminated.

8. The device of claim 7, wherein the measurement system is illuminated based on the depth of the device is inserted during use.

9. The device of claim 1, wherein the device further comprises of a suction component wherein the suction component is on the bottom of the device.

10. The device of claim 1, wherein the device vibrates.

11. The device of claim 10, wherein the vibration sequence of the device is dependent upon the depth the device is inserted during use.

12. The device of claim 1, wherein the measurement system uses symbols.

13. The device of claim 1, wherein the sexual penetration device is in the shape of dildo.

14. The device of claim 1, wherein the device is curved.

15. The device of claim 1, wherein the girth of the device varies in a wave manner along the length of the device.

16. The device of claim 1, wherein the device further comprises of a suction component.

17. A system, wherein a sexual penetration device comprises of a measurement system that measures the length of the device and further comprises of a length and a girth is provided.

18. A method for measuring insertion depth of an adult insertion device, the method comprising:
Providing an adult insertion device with a measurement system
Inserting the adult insertion device
Viewing the insertion depth by comparing to the number on the measurement system.

19. The device of claim 1, wherein the categorical terms are place and aligned at various length points on the measurement system, to demonstrate to the user's level of proficiency.
